(19) United States
(12) Patent Application Publication
(10) Pub. No.: US 2005/0192839 A1
(43) Pub. Date: Sep. 1, 2005

(54) Method and system for managing paperless claim processing

(75) Inventors: Don St. Jacques, Aurora, IL (US); Jody Sroga-Lyp, Valparaiso, IN (US); Cliff James, (US); Eric Gwynn, (US)

Correspondence Address: M. LISA WILSON;DUANE MORRIS LLP, 380 LEXINGTON AVENUE, NEW YORK, NY, 10168-0002, US

(73) Assignee: P2P Link LLC

(21) Appl. No.: 11/061,558

(22) Filed: Feb. 18, 2005

Related U.S. Application Data
(60) Provisional application No. 60/548,580, filed on Feb. 27, 2004.

(51) Int. Cl. G06F 17/60

(52) U.S. Cl. 705/2

(57) ABSTRACT

This invention pertains to a method for managing medical insurance claim's processing and bill payments whereby information related to a medical bill file having medical data, payment data and administrative data incorporated into a bill and associated attachment forms a logical association. Thereafter, each association is controllable such that access to specific information is restricted. The invention also pertains to a computer system comprising: input means operable to read at least one file containing one or more medical bill records and associated attachments associated with one of a plurality of medical providers; a memory in communication with said input means to store said at least one file; and a processor in communication with said memory to identify which medical records relate to same ones of a medical provider; a means to select one of said files in accordance with a control and restrict access to said selected records.

### CROSS-REFERENCE TO RELATED APPLICATIONS

The present application claims priority to U.S. Provisional Patent Application No. 60/548,580 filed Feb. 27, 2004.

### BACKGROUND OF THE INVENTION

This application is related to the field of document management and more specifically to a method for managing claim processing and bill payments.

### DESCRIPTION OF THE PRIOR ART

Through custom and more recently legal regulation medical patients must generally provide specific authorization before an organization such as a service provider or payer of medical bills may disclose protected patient medical records. In those instances where an organization desires to release medical record information, patients must received advanced written notice of the privacy practices of the organization and a copy of the patients' privacy rights. Therefore there is a large incentive to create systems that do not permit viewing or other accesses to certain information that in some instances may accompany a medical bill.

Conventional methods for managing claims for payment submitted by doctors, for example, continue to be a paper intensive operation. Doctors, health care providers or facilities, and pharmacies, in order to obtain payment for services performed on clients or products provided to clients, typically submit forms, in triplicate, to the client's insurance company. The insurance companies, in turn, have sought to reduce their burden and have imposed their own requirements on the forms and information that the doctors must provide.

The privacy provisions of the federal law, the Health Insurance Portability and Accountability Act of 1996 (HIPAA), apply to health information created or maintained by health care providers who engage in certain electronic transactions, health plans, and health care clearinghouses. With the advent of new laws, such as HIPAA and other regulations, there is an increased burden on both the health care provider and the insurance companies to insure privacy of medical records. These protections will begin to address growing public concerns that advances in electronic technology and evolution in the health care industry are resulting, or may result, in a substantial erosion of the privacy surrounding individually identifiable health information maintained by health care providers, health plans and their administrative contractors.

The increase in paper documents streaming into the insurance companies has also created problems in managing client accounts, verifying that the services provided are included within the insurance coverage, insuring that health care costs are properly paid and preventing fraud or duplication of payment. Electronic methods have been implemented that use computers to record the information provided on paper forms. However, this requires significant effort by the insurance company to establish and maintain the computer records and ensure proper access to the paper records and ancillary documents.

Hence, there is a need for a method and system that would allow the insurance companies some means to obtain and retain claim submission information electronically and further provide for controlled access to the submitted claim information without requiring access to paper records as the claim proceeds through the claim review and payment process.

### SUMMARY OF THE INVENTION

The present invention relates to a method for managing medical insurance claim's processing and bill payments comprising the steps of: digitizing information related to a medical bill file having medical data, payment data and administrative data incorporated into a bill and associated attachments, and establishing a logical connection between the medical data, payment data and administrative data and associated attachments, wherein each said logical connection is controllable. The logical connection also permits restricting access to specific data elements such that specific operators may or may not be authorized access to a medical record or administrative file.

The invention herein is also a computer system for managing medical insurance claim processing and bill payments comprising: input means operable to read at least one file containing one or more medical bill records and associated attachments associated with one of a plurality of medical providers; a memory in communication with said input means to store said at least one file; and a processor in communication with said memory operable to: identify which of said medical bill records relate to same ones of a medical provider; a means to select one of said files in accordance with a control and restrict access to said selected records to a designated reviewer; and a means to process each of said records identified as relating to said medical provider.

### BRIEF DESCRIPTION OF THE DRAWINGS

FIGS. 1a-1c illustrate conventional processes for claim review and subsequent payment;

FIG. 2a illustrates a block diagram of a system for electronically managing claim processing including a claim review process;

FIG. 2b illustrates a simplified block diagram of the present invention incorporated into the conventional process shown in FIG. 1a through 1c;

FIG. 3 illustrates a high level block diagram of the present invention;

FIG. 4 illustrates a second high level block diagram of the present invention;

FIG. 5 illustrates a computer system of the present invention;

FIG. 6 illustrates an exemplary process in accordance with the principles of the invention;

FIGS. 7a-7k illustrate exemplary visual displays associated with selected operations in accordance with the principles of the invention;

FIG. 8 illustrates a flow chart of an exemplary process for determining displays based on a selected action in accordance with the principles of the invention; and

FIG. 9 illustrates an exemplary relation between actions and secondary actions in accordance with the principles of the present invention.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION

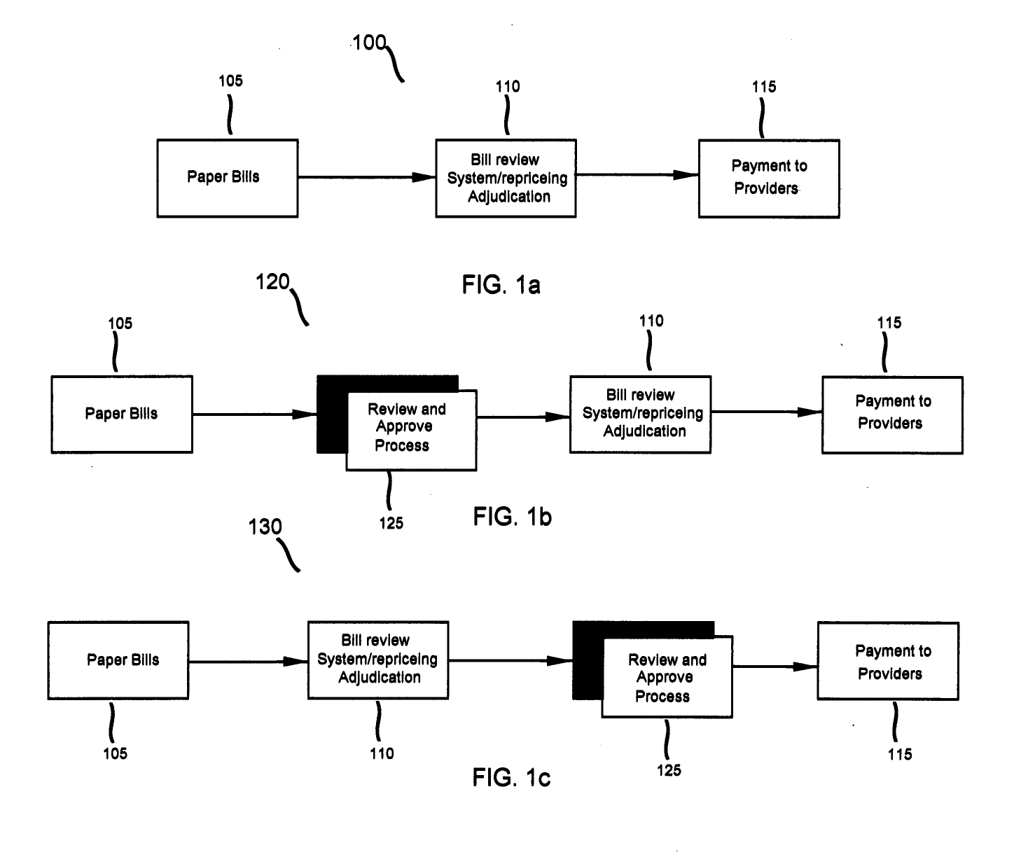

FIG. 1a illustrates a conventional method 100 that insurance companies use for processing claims for the payment of medial bills. As illustrated, bills 105 typically in a paper medium are provided to a bill review process 110 where individuals review, adjudicate and either accept, reject or adjust the claimed amount submitted. If the claim is not rejected, the claim is forwarded to the paying institution referred to as a payer for payment. FIG. 1b illustrates a second conventional method 120 that payment indemnifiers, such as insurance companies use for processing claims. In this case, bills 105 are provided to a review and approval process 125, where individuals review and either accept or reject the claim. If the claim is accepted, it is submitted to a bill review system 110, which in this case principally accepts or adjusts the claimed amount submitted. The claim is then forwarded to the paying institution or payer for payment 115. FIG. 1c illustrates a third conventional method 130 that insurance companies use in processing claims. In this case, paper bills 105 are provided to a bill review system 110 that reviews and accepts or adjusts the claimed amount submitted. The claim is then provided to a review and approval process 125 where individuals either accept or reject the adjudicated claim. If the claim is not rejected, the claim is forwarded to the paying institution or payer for payment 115. In either method, when the claim is rejected, the payment is delayed as the claim may return to the submitter for correction or to the client for verification.

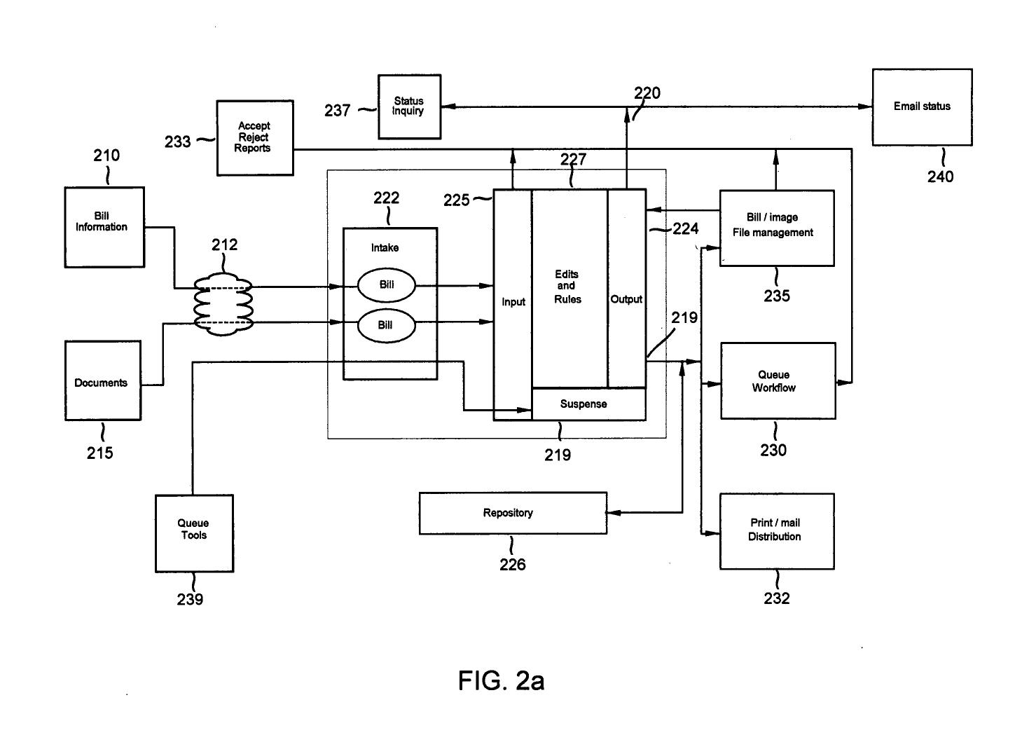

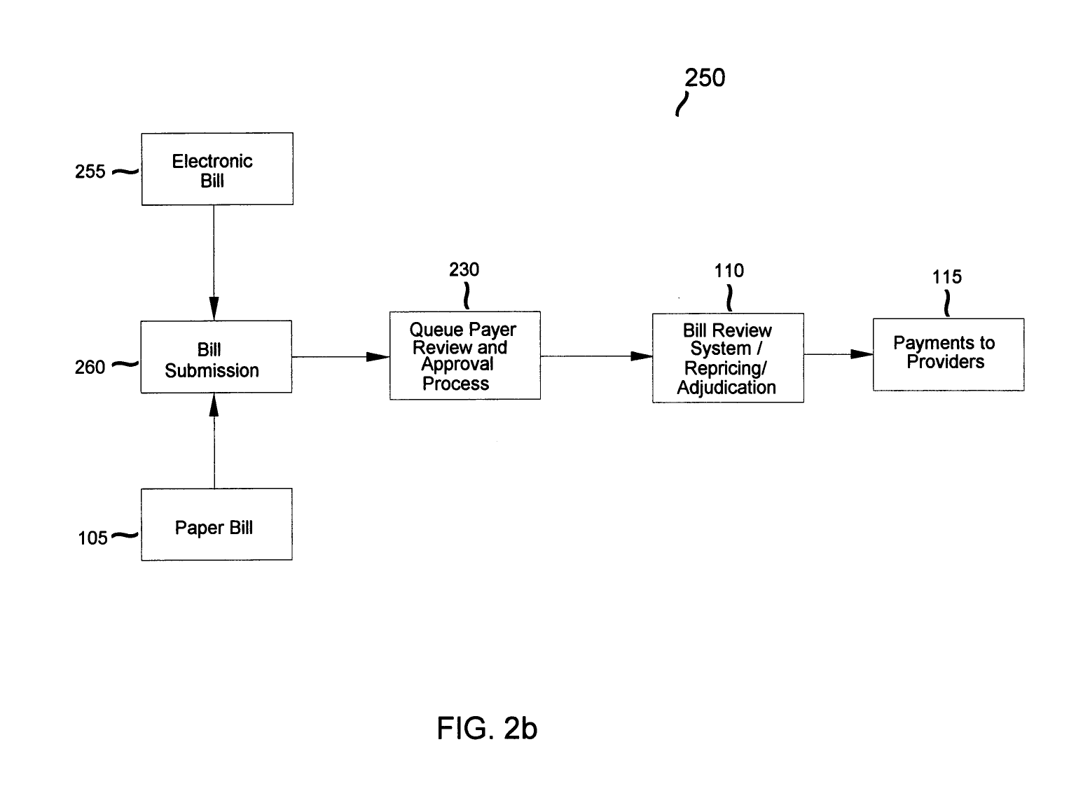

FIG. 2a illustrates a block diagram of a system for managing claims from health care providers, such as physicians, hospitals, and pharmacies, etc. At block 210, bill information that has been electronically encoded is supplied via network 212 to a computer processing center 220. Processing center 220 may further have access to documents, that represent letters and forms, etc., associated with its general operation or associated with specific clients or institutions. The documents may be either tangible or intangible, i.e., paper or electronically represented. Although network 212 is represented as a conventional electronic network, one skilled in the art would recognize that network 212 may be a conventional mail or overnight mail service that conveys tangible bills or documents. However, only in its electronic network form does the system allow for fully automated bill processing and adjudication.

Processor center 220 includes an intake station 222 that accepts the received bills and may request documents 215 in an electronic form that is associated with the claim. The collected data is then subject to rules regarding the manner and means of payment, the collected data is also matched to payer specific data for adjudication and processing and then provided to an output section for further distribution and handling. In one aspect, the information may be provided to a print and mail process 232 for distribution to certain payers. In another aspect, the information may be provided to a process 230, referred to herein as the queue workflow, which will be more fully described below. In yet another aspect of the invention, the information may be supplied to a management system 235 for subsequent processing, recording or archiving. Information regarding a claim may be electronically mailed 240 to the payer or referred to a status inquiry 237.

The management system 235 permits documents such as a bill as processed by the process center 220 to be imaged on a suitable computer display so that administrative personnel might inspect the bill, modify the bill, accept or reject 233 the bill or other kind of document. The document such as a bill processed during intake 222 is sent to an input processor 225, which conditions the bill data prior to submission to an edit and rules process 227.

The processor center 220 may also incorporate rules that permit viewing of the documents by authorized personnel. The rules may segregate the authorizations by virtue of a person's position (manager, specialist) or by name. Upon applying various rules specific to payers, medical conditions, patients and other institutions that have bearing on the payment of medical bills, the document is output 224 to one of the print/mail distribution 232, the queue workflow 230, the bill/image file management 235, or the repository 226 where the documents are stored permanently or temporarily in partial or full form. The system includes tools 239 which an administration may utilize to alter and amend documents held in suspense 219 workflow 230, the bill/image file management 235, or the repository 226 where the documents are stored permanently or temporarily in partial or full form. The system includes tools 239 which an administration may utilize to alter and amend documents held in suspense 219.

The system described in FIG. 2a provides for a computer method for managing an insurance claim payment to a provider of medical services comprising the steps of: reading the bill 210 at the intake station 222, storing and retrieving information related to medical bill records and related attachments that may contain medical data referred to as documents 215 and establishing one or more logical associations between the medical data, the payment data and administrative data incorporated into the bill 210 as electronic records and associated attachments such as the documents 215, and wherein access to medical data, payment data and administrative data and associated attachments are based upon one or more rules for combining the logical associations having been programmed into the processing center 220 edits and rules process 227.

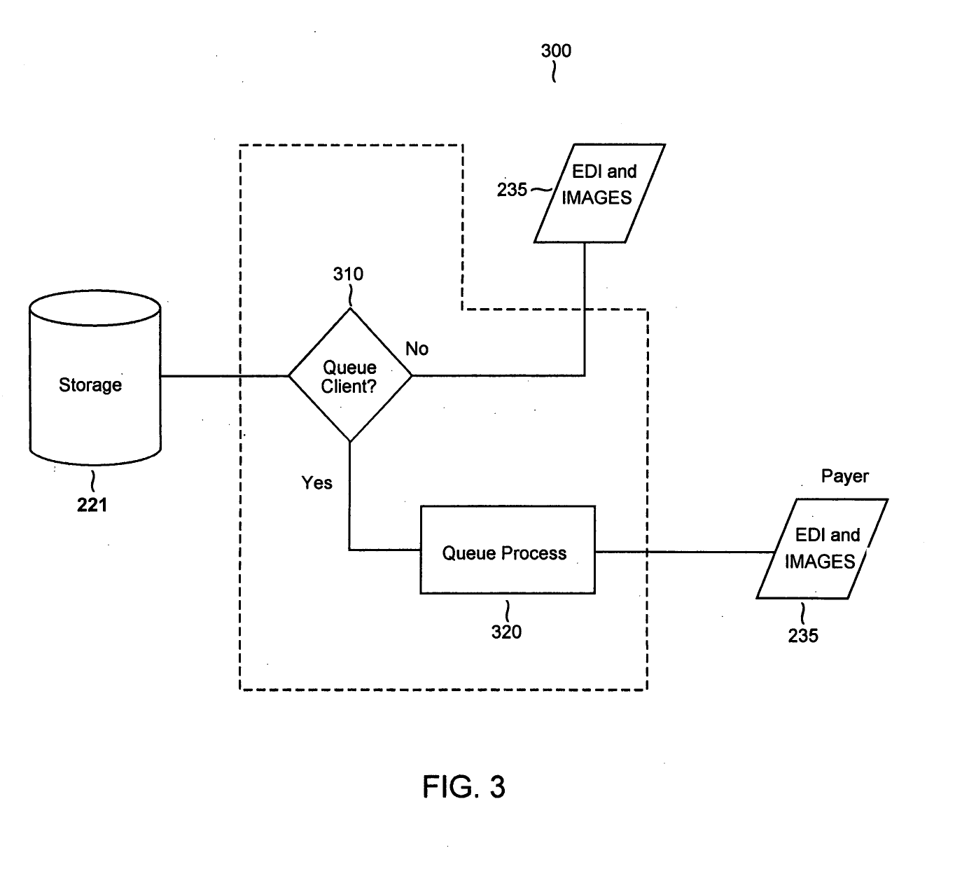

FIG. 2b illustrates a simplified block diagram 250 of a system incorporating the queue workflow process 230. In this case, either paper bills or claims 105 or electronic bills or claims 255 are submitted to a bill submission process 260. Although not shown, it would be recognized that paper bills or claims 105 are converted into an electronic format such as a portable document format or tagged image file format as by way of example. Such conversion is well-known in the art and need not be discussed in detail here. The electronic bill or converted paper bill is then provided to queue workflow process 230 for processing, as will be more fully described with regard to FIG. 3. The claim is then provided to bill review process 110 under the authorization controls as to personnel as previously indicated and payment process 115 as previously described. Although the present invention is described with regard to the processes shown in FIG. 1a, it would be within the knowledge of those skilled in the art to incorporate the instant invention into the systems shown in FIGS. 1b and 1c without undue experimentation.

FIG. 3 illustrates a high-level block diagram 300 of the queue workflow 230 process shown in FIG. 2a. In this diagram, a database 221 provides information items to the queue workflow 230 process and a decision is made at block 310 as to whether the information is associated with a current client. In this case, clients may be one or more companies whose personnel are afforded access to a processing center utilizing the present invention to process documents such as bills. Again, the system would only permit authorized personnel to access the processing center. The system determines at block 310 whether the bill data needs further queue processing 320. At decision block 310, if the decision is “no”, then the information is supplied directly to the bill/image file management process 235 as described in FIG. 2a. However, if the answer is “yes”, then the information is provided to queue process 320 for further processing. In this case, the information may be a loose accumulation of data items associated with the initially submitted claim. These data items may include notes collected or actions taken during the current review process or previous review processes. Following the queue process 320, the information is supplied to the bill/image file management process 235.

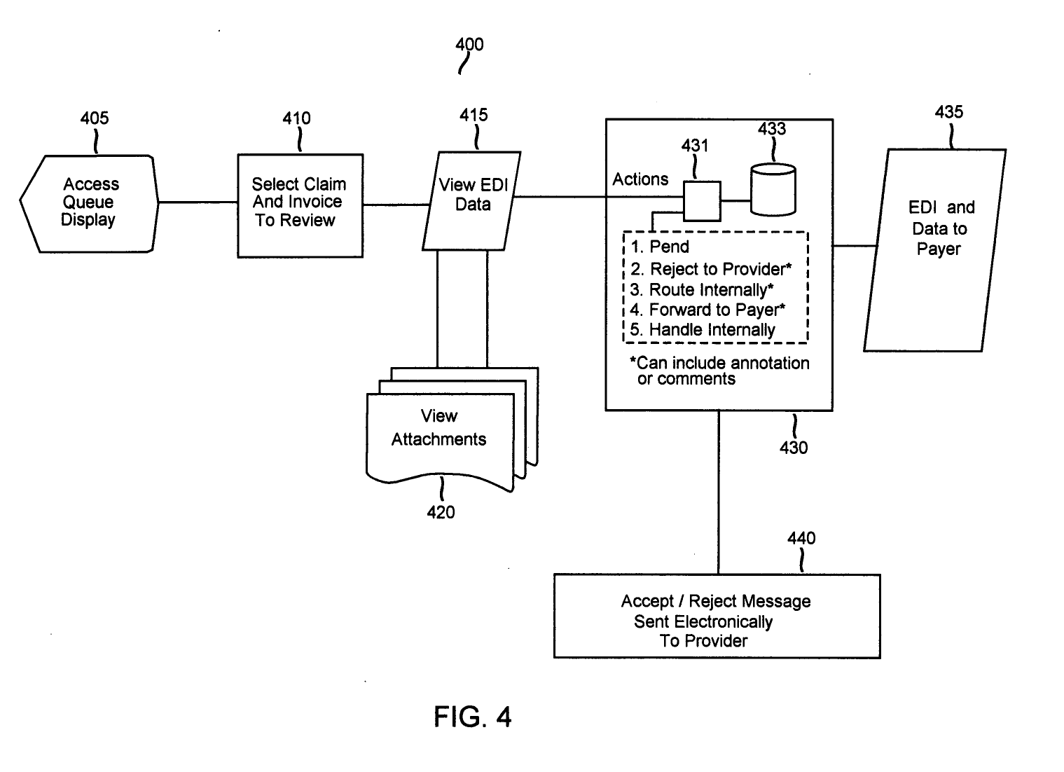

FIG. 4 illustrates an exemplary high-level block diagram of the process 235 shown in FIG. 2a. In this illustrated example, the claim information provided to process 235 may be viewed at an access queue display block 405. Claim information may be individually selected from a plurality of claim information provided at block 410. Each of the information items is associated with the selected claim information where it is viewed at block 415. Any attachments related to the claim information may be viewed at block 420. As previously discussed, these information items may include notes recorded or actions taken on the selected claim. At block 430, a further action 431 on the selected claim may then be taken and stored 433. In this illustrated case, actions such as pending, reject, internal routing, and acceptance may be taken based on rules associated with the individual insurance company. For example, one insurance company may have one first maximum level of payment for a first client type and a second level of payment for a second client type. In addition, different companies may have different maximum payment limits, even if they also utilize the exemplary first and second maximum payment limits as described.

After processing, a message 440 is provided to the claim provider or submitter indicating whether the claim has been accepted or rejected. If the claim is accepted, then an indication is provided to the payer at block 435. By way of example and not limitation, the information further may be provided to a document processor that may prepare letters of payment and amount of coverage.

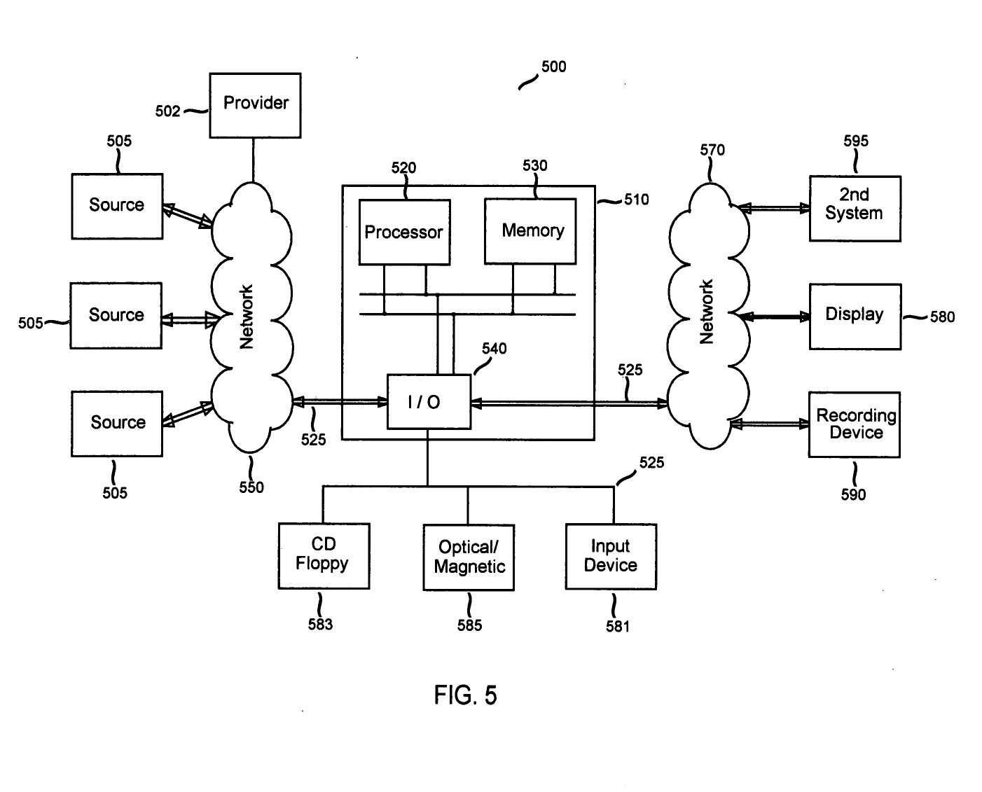

FIG. 5 system 500 illustrates an exemplary process in accordance with present invention. A firewall (unshown) may be installed in the hardware or software to restrict access based on various rules that are deemed necessary by the provider 502 of medical billing services. Furthermore the system may determine if the messages or files transmitted or received are, safe. Additionally, the system 500 seeks to authenticate that the institution or person who transmits data from sources 505 is who they say they are and who the institutions and persons are that are authorized to retrieve it. Authentication determines the true identity of the institution, group or individual permitted to view the data. To verify the permitted system user, the present invention contemplates a basic authentication using a password, but also more precise methods such as biometrics (fingerprints, retina scans). As such the system combines logical associations to restrict account access to designated operators. In the event that unauthorized accesses are attempted, the process includes the further step of reporting upon detection of such an event.

In system 500, input data representing bills, medical records and related attachments is transmitted to an input/output device 540 from data sources 505 over network 550 and is processed in accordance with one or more software programs executed by computer system 510. The results of processing may then be transmitted over network 570 for viewing on display 580, as input to a recording device 590 and/or to a second processing system 595.

More specifically, computer system 510 includes one or more input/output devices 540 that receive data such as shown in FIG. 2a bill information 210. The received data is then applied to processor 520, which contains the process center 220 described in FIG. 2a, which is in communication with input/output device 540 and memory 530. Input/output devices 540, processor 520 and memory 530 may communicate over a communication medium 525. Communication medium 525 may represent a communication network, e.g., ISA, PCI, PCMCIA bus, one or more internal connections of a circuit, circuit card or other device, as well as portions and combinations of these and other communication media. Processor 520 may be representative of a handheld calculator, special purpose or general purpose processing system, desktop computer, laptop computer, palm computer, or personal digital assistant (PDA) device, etc., as well as portions or combinations of these and other devices that can perform the operations illustrated herein.

In one embodiment, processor 520 may include code which, when executed, performs the operations as described with respect to FIG. 2a, FIG. 2b, FIG. 3 and FIG. 4. herein. The code may be contained in memory 530, read or downloaded from a memory medium such as a CD-ROM or floppy disk represented as 583, or may be read from a magnetic or optical medium 585, which are accessible by processor 520, when needed, or provided by manual input device 581, such as a keyboard or a keypad entry. Information items provided by input device 585 and/or magnetic medium 583 may be accessible to processor 520 through input/output device 540, as shown. Further, the data received by input/output device 540 may be immediately accessible by processor 520 or may be stored in memory 530. Processor 520 may further provide the results of the processing shown herein to display 580, recording device 590 and/or a second processing unit 595 through I/O device 540.

As one skilled in the art would recognize, the terms processor, processing system, computer or computer system may represent one or more processing units in communication with one or more memory units and other devices, e.g., peripherals, connected electronically to and communicating with at least one processing unit. Furthermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit.

As would be understood, the operation illustrated herein may be performed sequentially or in parallel using different processors to determine specific values. Processor system 510 may also be in two-way communication with each of the sources 505 over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, networks 550 and 570 may also be internal networks, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

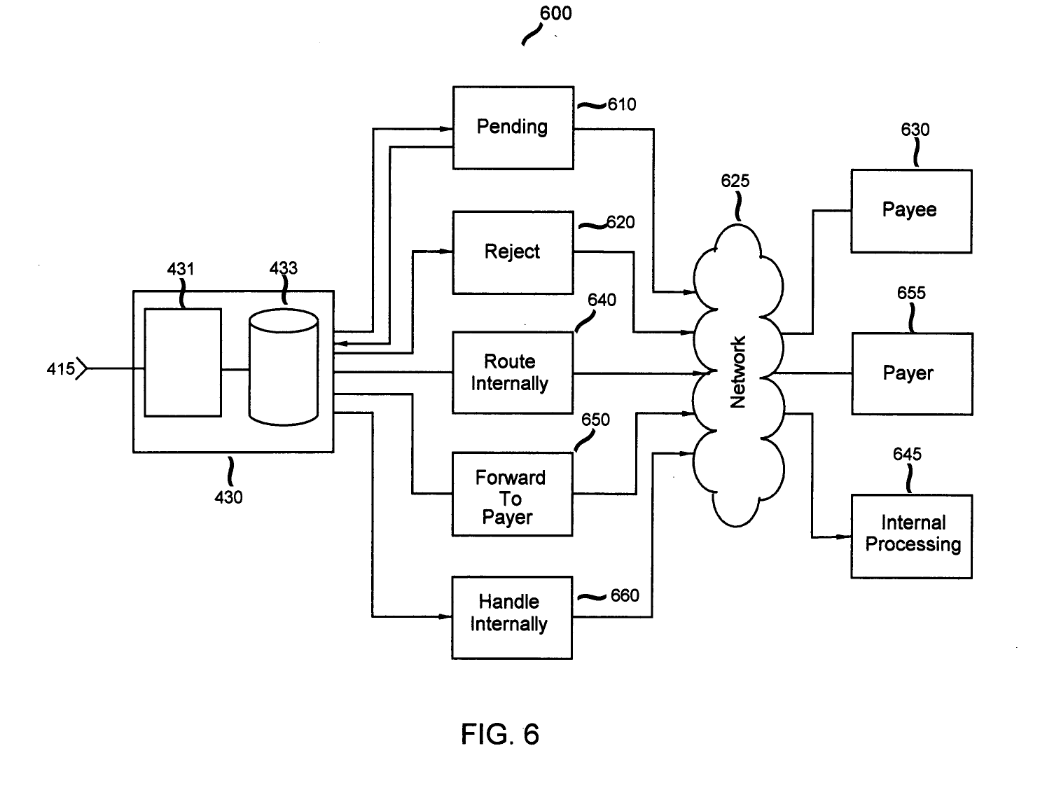

FIG. 6 depicts a block diagram 600 of an exemplary process associated with action processing 430 shown in FIG. 4. In this illustrated process, action process 430 directs, based on a designated rule set, information associated with a claim to additional processes for further processing. For example, if claim information is determined to be insufficient to complete the payment process then the claim information may be indicated as pending 610 and routed 640 internally to additional users to incorporate further information or to correct the deficiency or held in suspense as shown FIG. 2a, 219, until required additional information is provided. The information may be maintained in the process center 430 or provided, via a network 625, to another center, either a physically disjoint or logically virtual center. For example, internal processing 645 may represent processing executed at process center 430 or a virtual center that is physically disjoint from process center 430 or may be processed in a second process center. In another aspect, if, in accordance with the designated rule set, the claim is not payable, then a reject process 620 is invoked and the bill may be handled 660 internally. Thus, if the rule set indicates a maximum reimbursement has already occurred, then the claim is rejected and notice may be provided to the claim submitter or payee 630 via network 625. If, on the other hand, the claim is accepted, then information is provided to forward to payer processing 650 and the information is provided to a payer 655 via network 625.

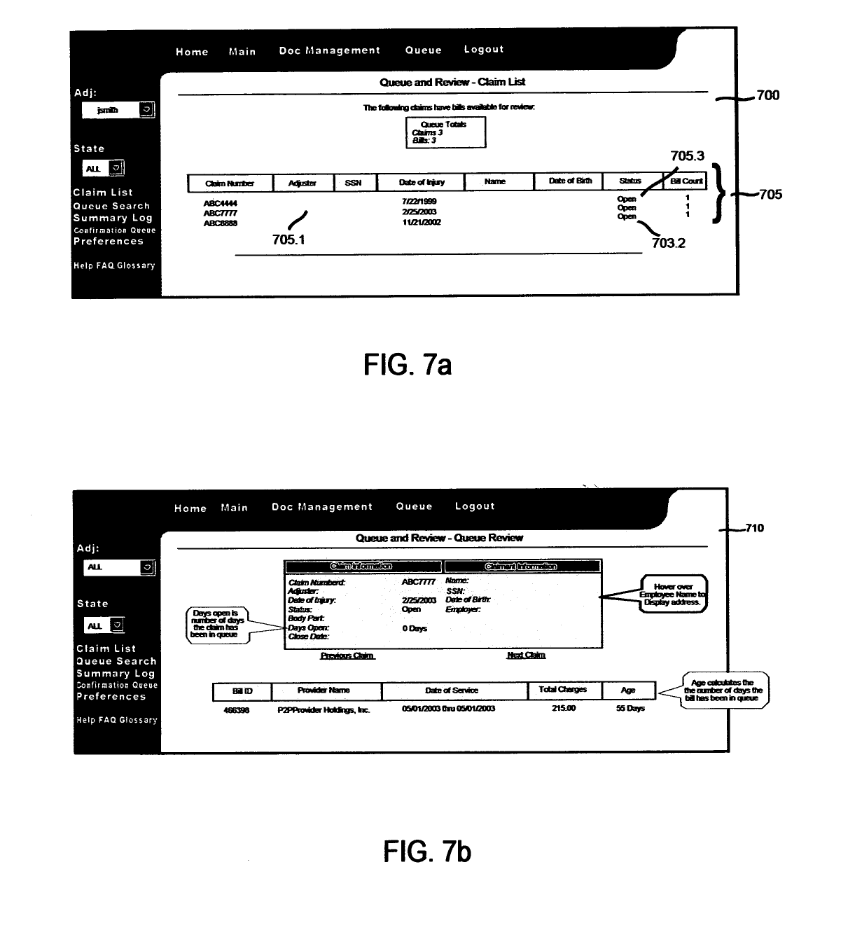

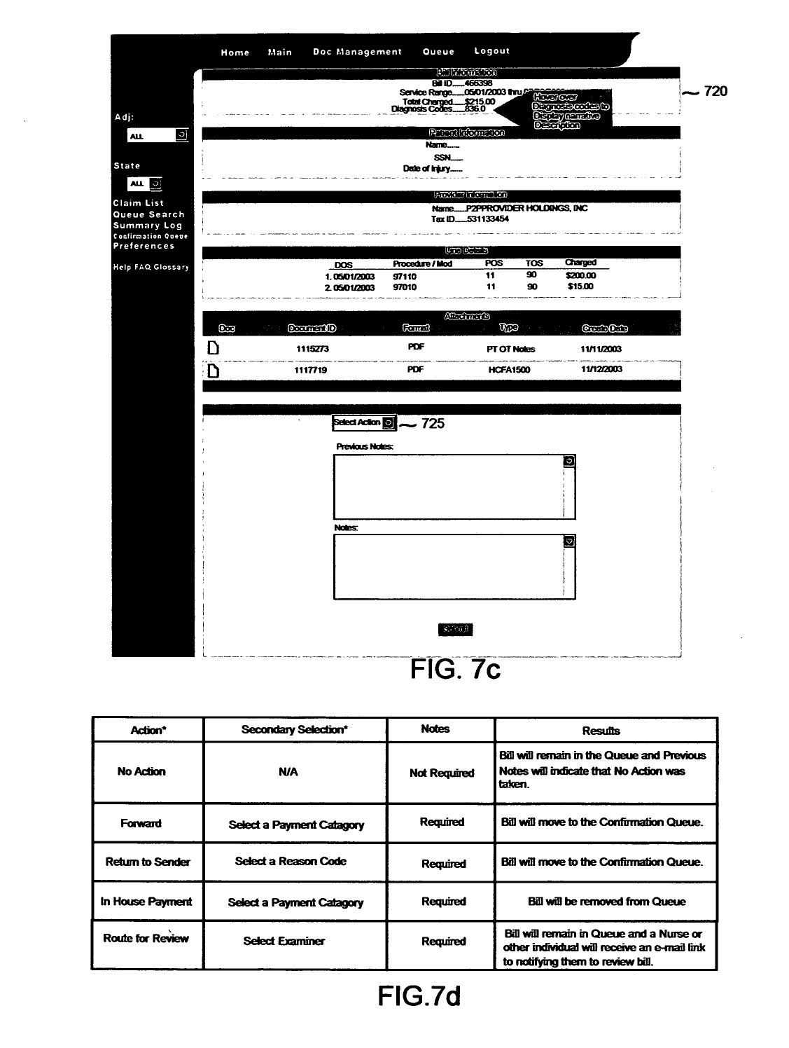

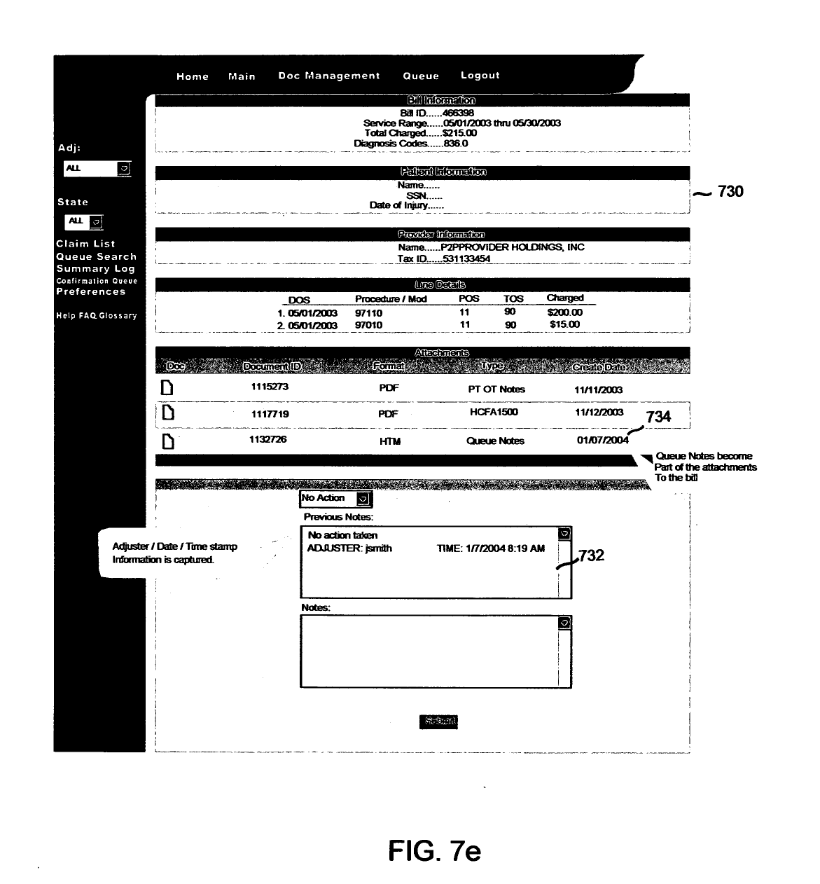

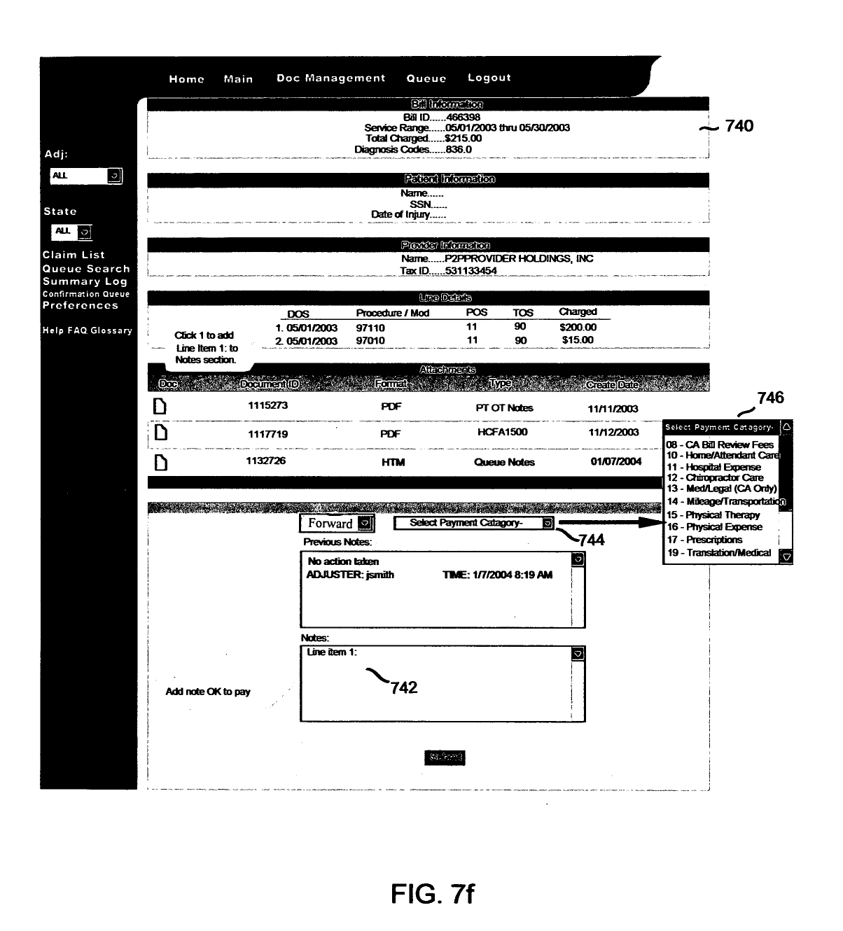

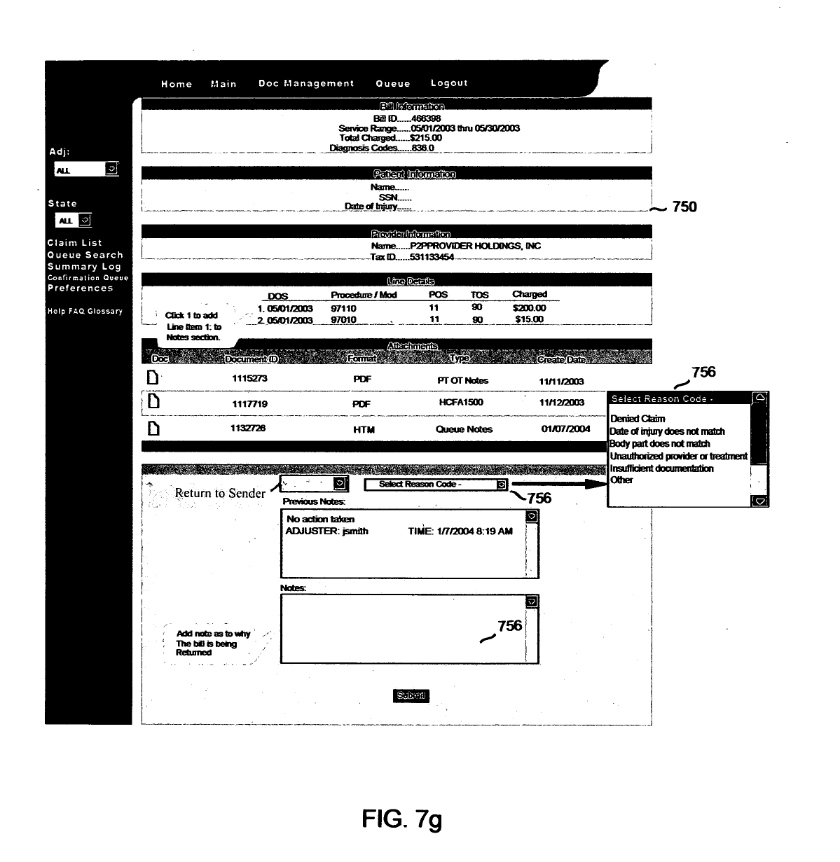

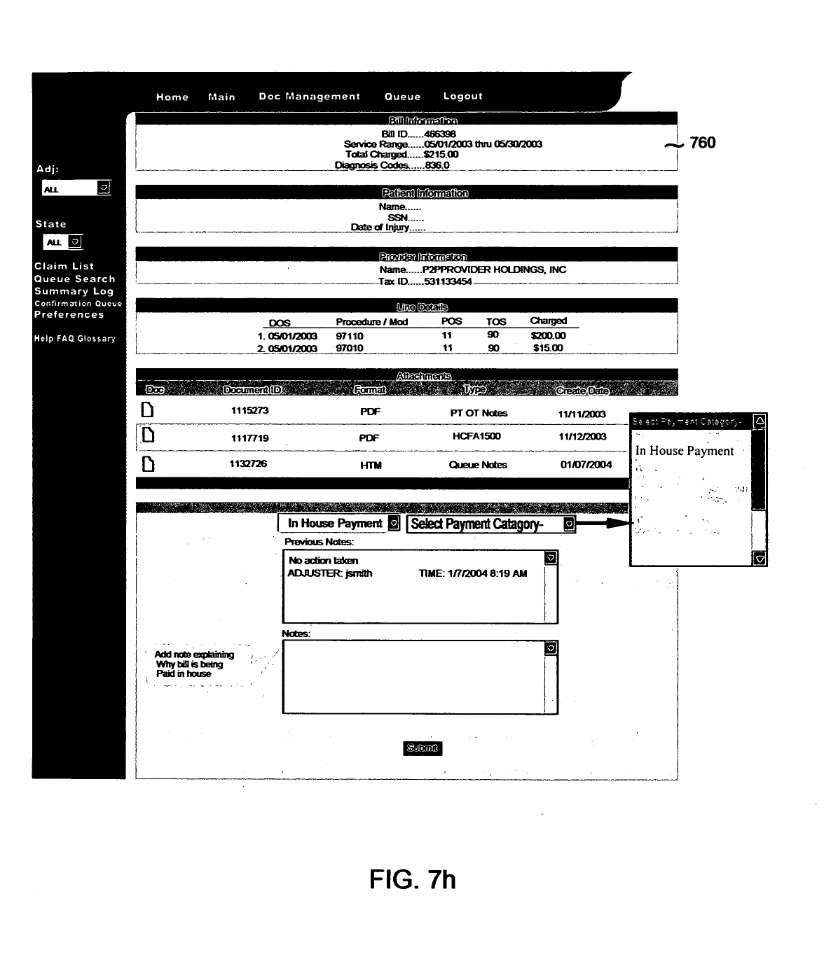

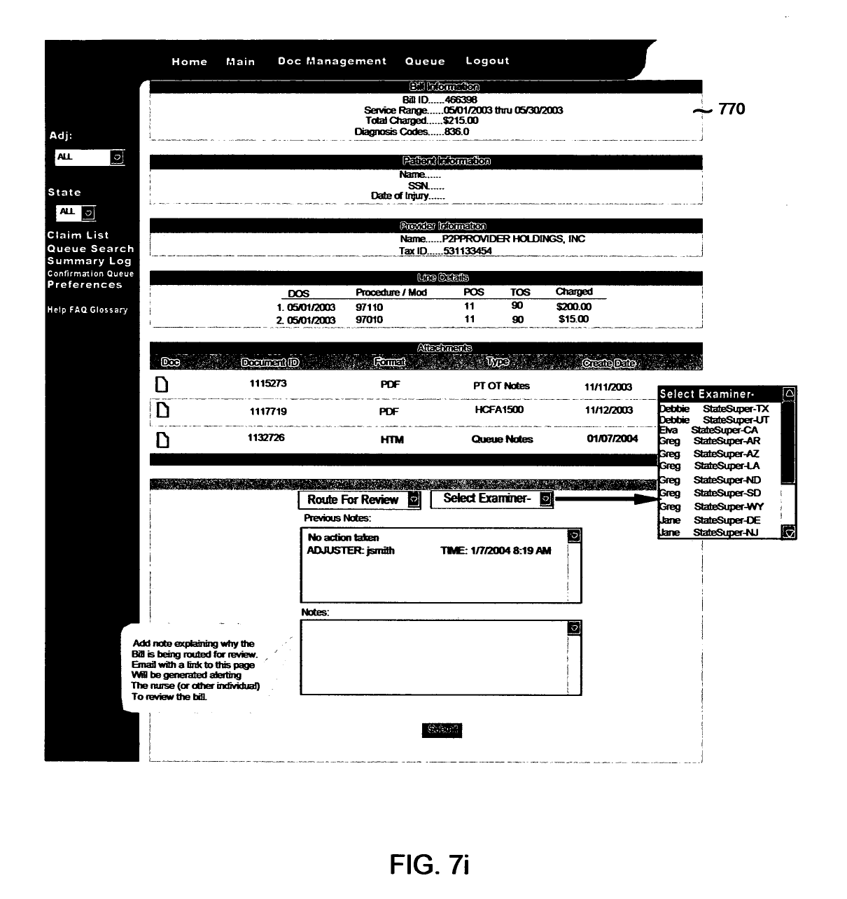

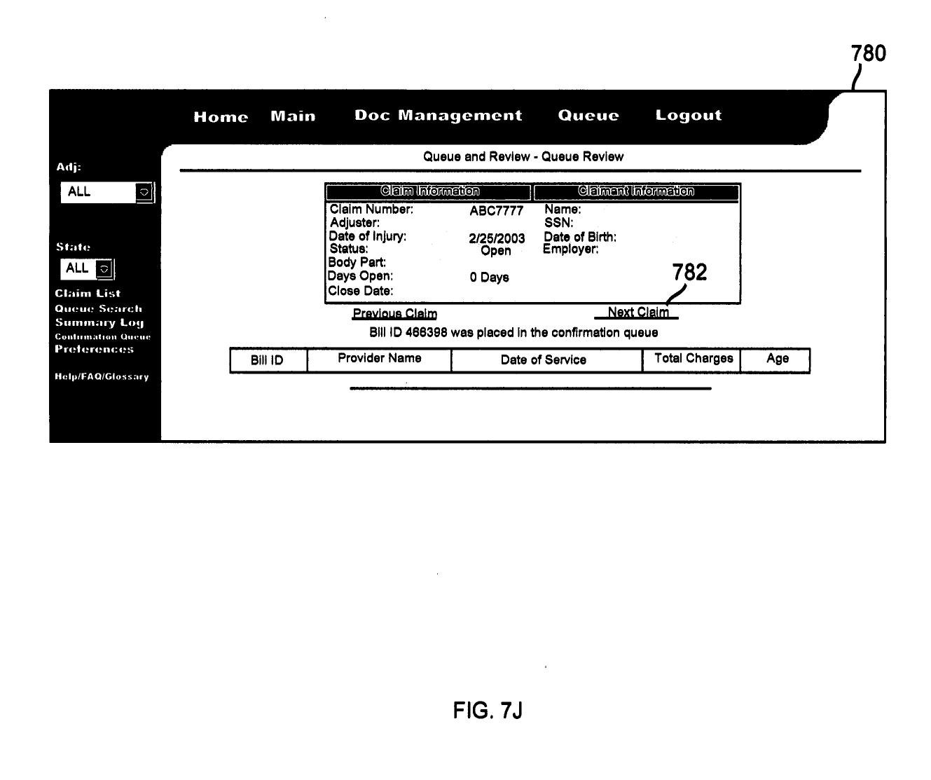

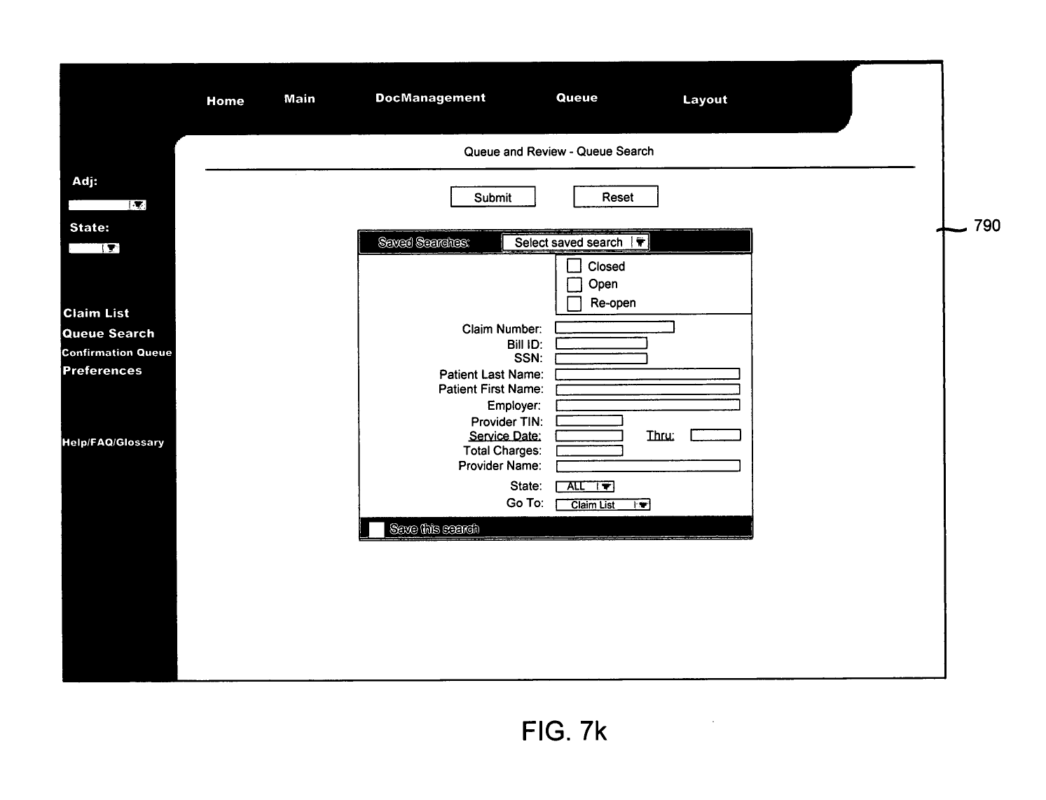

FIG. 7a illustrates an exemplary display 700 depicting a plurality of claims submitted 705.1, for processing. Typically the display indicates a claim number, the date of injury and a status. In the example shown, claim number ABC4444 pertains to an injury that occurred on Jul. 22, 1999 and the status 705.3 is Open. Likewise other claims have corresponding status such as status 703.2 pertaining to claim number ABC8888. Each of the submitted claims may then be individually selected for further processing. FIG. 7b illustrates an exemplary display 710 associated with a selected claim. In this display, information such as client name, employer name, etc., associated with the claim ABC7777 is made available. FIG. 7c illustrates an exemplary display 720 associated with bill or claim information. In this display, information such as bill identification, service range, diagnosis codes, etc. are made available. Additional information such as insurance provider and associated documents are available for review. As illustrated, an action as more fully described below may be selected by the user as shown in box 725.

FIG. 7d illustrates exemplary choices associated with selectable action in box 725. For example, when No Action is selected, neither further action, i.e., secondary action, nor notes are required. A direction as to the Results indicates what will occur with the bill. However, if under the column Action, a Return to Sender action is selected, then in the Select a Reason Code box the user must provide a reason code that will be included in the bill or claim, and the bill or claim will be moved to a confirmation queue that initiates processes to return the claim to the sender with the appropriate reason for return. Similarly, if a Route for Review action is selected, then a Select Examiner action is also required, along with a note. The bill or claim is moved to a queue that initiates processes that forward the information to the selected examiner. In another aspect of the invention, only an indicator is provided to the selected examiner to notify them of their need to review the claim or bill. In this case, the examiner may select the claim information.

FIG. 7e illustrates an exemplary display 730 depicting a display when no action is selected. In this case the No Action is recorded 732 and a notice date 734 is included as an attachment to indicate that a note has been added.

FIG. 7f illustrates an exemplary display 740 when a claim has been accepted for payment. In this case, a note 742 has been added to indicate the action of accepted payment has occurred. Further, a new selection Select Payment Category box 744 dynamically opens a list of payment categories that allows the user to include a payment category. Payment categories may be accessed via a pull-down menu 746 that includes pre-filled categories.

FIG. 7g illustrates an exemplary display 750 when a return to sender action has been taken. Similar to the display shown in FIG. 7f, a note 752 may be added and a new selection box 754 is opened. New selection box 754 may allow a direct input of the reason for return or may allow, as shown, a pull-down menu 756 containing a list of reasons for return.

FIG. 7h illustrates an exemplary display 760 when an in-house payment action is selected. FIG. 7h operates similar to the operations described in FIGS. 7f and 7g and need not be discussed in detail.

FIG. 7i illustrates an exemplary display 770 when an in-house payment action is selected. FIG. 7i operates similar to the operations described in FIGS. 7f and 7g and need not be discussed in detail.

FIG. 7j illustrates an exemplary display 780 for confirmation of a claim or bill reviewed by at least one second reviewer. In this case, a list of claims for review is presented to the designated reviewer from which the reviewer may individually select one claim. After review, a next claim may be selected for review by either selecting the claim specifically or by depressing the next claim 782 icon.

FIG. 7k illustrates an exemplary display 790 used to search a data base for claims associated with one or more search criteria. For example, searching may be conducted using criteria such as claim number, social security number, patient name, etc., individually or in combination.

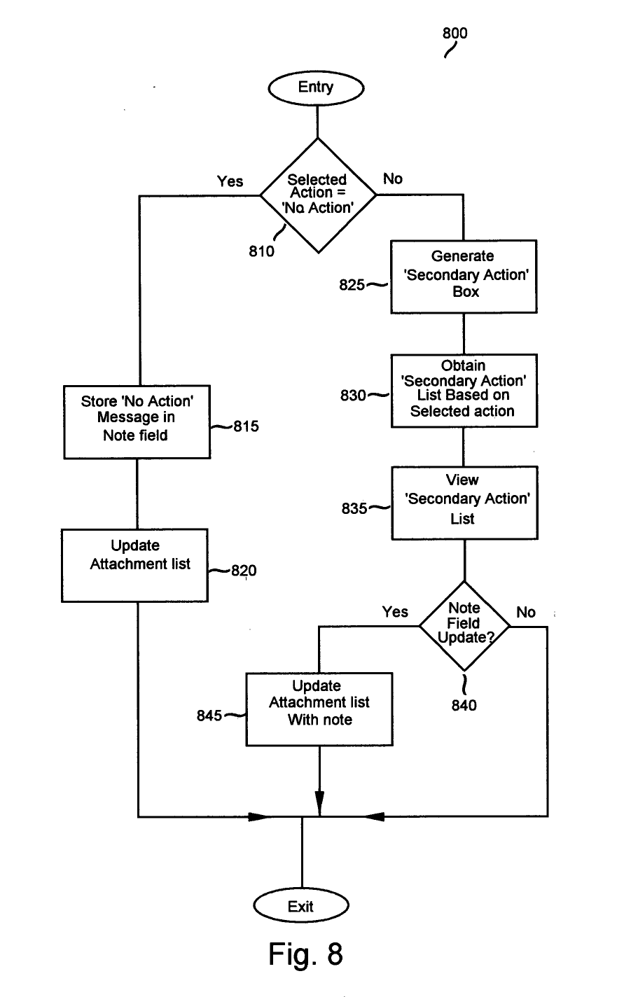

FIG. 8 illustrates a flow chart 800 of an exemplary process for determining what actions and what displays will occur based on a selected action 810. A determination is made whether the selected action 810 is one of no action. If the answer is “yes”, then a “no action” message is dynamically entered into the note field, at block 815, and the document attachment list is updated at block 820. However, if the answer is “no”, then a secondary action box is generated on the display at block 825 and a list of secondary actions associated with the selected action is obtained at block 830. At block 835 the obtained list of secondary actions is made viewable when an operator elects to view such list. In another aspect, the list may be made available to the user dynamically. At block 840, a determination is made whether a message or note has been entered into the note field. If the answer is “yes”, then the attachment list is updated 845 with the entered message. Otherwise, processing is ended.

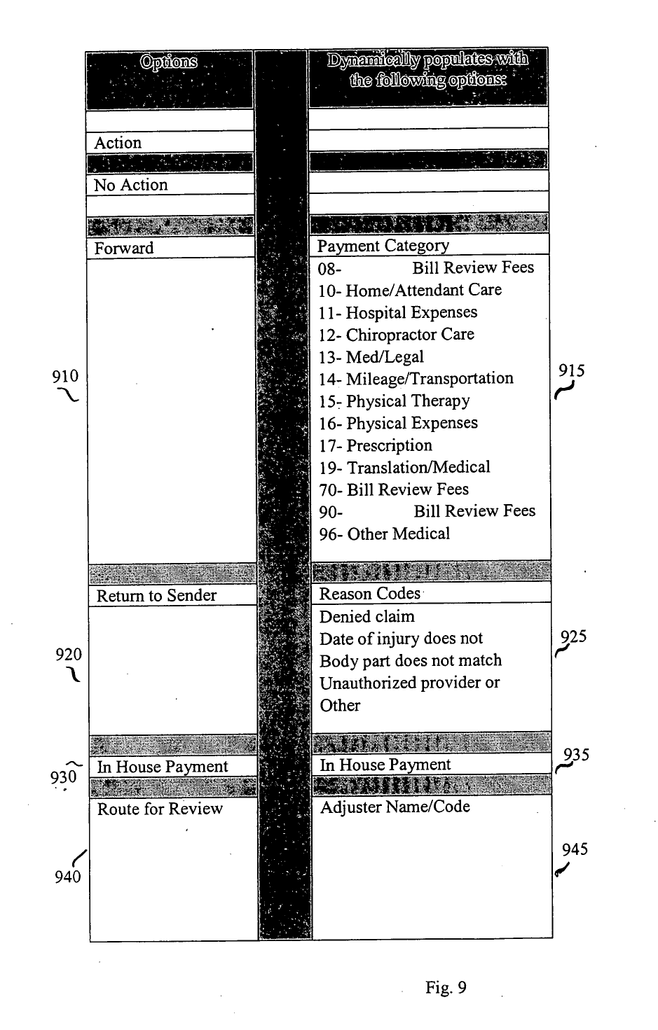

FIG. 9 illustrates exemplary secondary action lists or Options associated with each of the actions shown in FIG. 7d. Recall that FIG. 7d illustrates exemplary choices associated with selectable action in box 725. For example, when No Action is selected, neither further action, i.e., secondary action, nor notes are required. If Forward 910 is chosen then the predetermined list of Payment Category 915 may be selected. In some instances the rules associated with an insurance company payer may have one first maximum level of payment for a first client type and a second level of payment for a second client type.

If Return to Sender 920 is chosen as an action, then the predetermined list of Reason Codes 925 (see, FIG. 7d, Select a Reason Code) offers reasons to select. For example, for “Return to Sender” action 920, reason code 925 may be selected from a pre-determined list of reasons such as “Denied claim,” “Date of injury does not match,” Body part does not match,” “Unauthorized provider,” “Other.” Similar secondary actions are shown associated with the selected action. In House Payment 930 refers to an In House Payment 935 that would not be sent to an outside payer, but may remain with the processing center to pay. The route for Review 940 permits identifying an Adjuster Name/Code 945. One skilled in the art would recognize that the secondary actions for each action or the number of actions may be significantly altered without changing the scope of the invention and thus has been contemplated.

In accordance with the principles of the invention, once the bill or claim is entered, the digital representation of the bill and each of the attachments, are maintained as logically connected or associated data elements. In this manner, specific embodiments of bills, notes, comments, actions, or other attachments may be accessible by designated operators or users without requiring a complete file. In one aspect of the invention, each data element may also be individually controlled to allow or prevent access to specific data items to designated users. Hence, in this aspect of the invention a rule based system may be used to dynamically attach authorization codes to data elements, individually or as a group. For example, once a bill or claim has been reviewed and should the bill be returned to the submitter, the submitter is not allowed access to the reviewer's notes, comments or document. As another example, individual authorization codes assigned to specific data items assist in ensuring privacy of client information to unauthorized users. For example, client's or patient's personal information need not be revealed to a reviewer who is merely checking coverage.

In another aspect, as a digitized bill is ready for submission to a payer, parties with privileges or access are able to determine, monitor and track the location and status of each of the data items associated with the bill or claim. For example, operations that have been performed on a selected bill up to the present date and the next immediate impending action may be viewed. This is advantageous over the present document transmittal system, where no such audit trail exists and it is very hard to tell the current status of a selected claim.

In still another aspect, the audit trail operation provides further benefit as the provider, in cases of a rejection due to minor or clerical error, is not required to begin the submission process from scratch, as the digitized data elements and associated audit trail allow the submitter or provider to correct the deficits/errors in the bill and still maintain its place in the claim review and evaluation process. Hence, the corrected bill or claim is timely reviewed and prepared for the payer rather than delayed due to, in cases, minor errors. Thus, when a bill is rejected, a completely new bill need not be submitted, wherein the whole bill review and evaluation cycle starts over again. Thus a significant saving in costs is achieved, to the provider or bill submitter in limiting the time of outstanding receivable and to the payer in not duplicating work that had previously been performed.

As one skilled in the art would appreciate, each of the data items associated with a bill or claim may be retained, in an associated electronic file, similar to a paper file, or may be associated using known electronic means, such as document identifiers and associated references. In this latter case, data items, representative of notes, comments, actions, etc., may thus be physically stored on one or more processors or memory areas that may be physically connected via a network, such as an internal network, a local area network, or a wide area network such as the Internet, as is shown in FIG. 5.

It is expressly intended that all combinations of those elements that perform substantially the same function in substantially the same way to achieve the same results are within the scope of the invention. Substitutions of elements from one described embodiment to another are also fully intended and contemplated.

1. A computer method for managing an insurance claim payment comprising the steps of:
inputting to a computer system one or more medical bill records and related attachments containing therein medical data and payment data and establishing one or more logical associations among the medical data and payment data such that accessing medical data, and payment data are based upon one or more rules.

2. The computer method as in claim 1 comprises the further step of combining logical associations designating access to one or more bill records to specific operators.

3. The computer method as in claim 1 comprises the further step of combining logical associations designating access to one or more related attachments to specific operators.

4. The computer method as in claim 1 further comprising the further step of maintaining a database to store the medical bill record having medical data, payment data and administrative data and the associated attachments.

5. The computer method as in claim 1 wherein, inputting to a computer includes reading, storing and retrieving information.

6. The computer method as in claim 1 further comprises the further step of combining logical associations to dynamically create authorizations to retrieve medical bill records by attaching data elements to the medical bill record having medical data, payment data and administrative data and the associated attachments.

7. The computer method as in claim 6 comprises the further step of combining logical associations to authorize operator privileges to access selected controlled data elements.

8. The computer method as in claim 2 comprises the further step of combining logical associations to restrict account access to designated operators.

9. The computer method as in claim 3 comprising the further step of creating a record comprised of notes, comments and related documents upon access of the medical data, payment data and administrative data and associated attachments by the bill reviewer.

10. The computer method as in claim 9 wherein, the record comprised of notes, comments and related documents is returned to the database.

11. The computer method as in claim 9 comprises the further step of combining logical associations to deny specific operators access to the record of notes, comments and related documents.

12. The computer method as in claim 5 comprising the further step of submitting the bill for payment once medical data, payment data and administrative data and associated attachments are reviewed by the bill reviewer.

13. The computer method as in claim 4 comprises the further step of combining logical associations to assign designated logical elements to ensure the privacy of medical information.

14. The computer method as in claim 5 comprises the further step of combining logical associations to deny access of medical information to operators who are only checking an insurance coverage.

15. The computer method as in claim 1 comprising the further step of determining, monitoring and tracking the location and status of each of the records.

16. The computer method as in claim 1 comprising the further step of determining that the insurance claim payment to a provider of medical services is ready for payment.

17. The computer method as in claim 16 comprising the further step of viewing the next immediate impending action when the bill is ready for submission.

18. The computer method as in claim 3 comprising the further step of generating an audit trail to track the current status of a selected claim when the bill is ready for submission to a payer.

19. The computer method as in claim 4 comprising the further step of generating an audit trail as a means whereby a rejection of a bill does not required the reviewer to cycle the submission process from the beginning.

20. The computer method as in claim 16 wherein the data elements and associated audit trail allow the submitter to correct the deficiencies and errors in the bill without altering its position in the claim review and evaluation process.

21. The computer method as in claim 1, comprising the further step of displaying the medical data, payment data and administrative data and associated attachments.

22. The computer method as in claim 1 comprising the further step of displaying bill identification, service range, and medical diagnosis codes.

23. A computer method for managing an insurance claim payment from a provider of medical services comprising the steps of: reading at least one file containing a plurality of medical bill records and associated attachments, each file comprising a plurality of accounts for a medical provider; identifying which of said plurality of records relate to medical data and payment data and establishing one or more logical connections among the records and one or more associated attachments in accordance with rules for restricting access to selected records and selected associated attachments.

24. The computer method as in claim 23 comprising the further step of reporting the results of processing of each restricted account selected.

25. The computer method as in claim 23 comprising the further step of storing the results of processing of each restricted account selected.

26. The computer method as recited in claim 23 wherein the further step of identifying includes validating said records.

27. The computer method as recited in claim 23 wherein said selection is from the group consisting of individual names, individual professional qualifications, management company accessing the records.

28. The computer method as recited in claim 23 wherein said restriction is determined manually.

29. The computer method as recited in claim 23 wherein said further step of reporting who accessed the records.

30. The computer method as recited in claim 23 wherein the further step of reporting upon detection of an unauthorized access.

31. The computer method as recited in claim 23 wherein the records contain claim information.

32. The computer method as recited in claim 23 wherein one element of claim information may be individually selected from a plurality of claim information.

33. The computer method as recited in claim 23 wherein one element of a selected claim includes notes recorded or actions taken on the selected claim.

34. The computer method as recited in claim 23 wherein actions taken on the selected claim includes one of a group of pending, reject, internal routing, or accepting the claim.

35. The computer method as recited in claim 23 wherein actions taken on the selected claim are based on rules associated with an insurance company.

36. The computer method as recited in claim 23 wherein actions the rules associated with the insurance company have one first maximum level of payment for a first client type and a second level of payment for a second client type.

37. The computer method as recited in claim 23 wherein the further step of processing comprises crediting or debiting said selected ones of said accounts.

38. The computer method as recited in claim 23 wherein the further step of processing comprises
reconciling said selected account.

39. The computer method as recited in claim 23 wherein the further step of processing comprises creating bills.

40. The computer method as recited in claim 23 wherein the further step of processing comprises determining disbursements.

41. The computer method as recited in claim 23 wherein the further step of processing comprises generating notices.

42. The computer method as recited in claim 23 wherein a message is provided to the medical claim provider indicating the claim has been accepted or rejected.

43. The computer method as recited in claim 23 wherein a message is provided to the medical claim provider indicating the claim is to be returned to sender.

44. The computer method as recited in claim 23 wherein a message is provided to the medical claim provider indicating no action on the claim.

45. The computer method as recited in claim 23 wherein a message is provided to the medical claim provider indicating a reason code for no action.

46. The computer method as recited in claim 23 wherein the bill or claim is moved to a confirmation queue that initiates processes to return the claim to the sender with the appropriate reason for return.

47. The computer method as recited in claim 23 wherein a route for review action is selected.

48. The computer method as recited in claim 23 wherein a select examiner action is selected.

49. The computer method as recited in claim 23 wherein a note is added and a new selection box is opened.

50. The computer method as recited in claim 23 wherein the new selection box allows a direct input of the reason for return.

51. The computer method as recited in claim 23 wherein a pull-down menu is opened containing a list of reasons for return.

52. The computer method as recited in claim 23 wherein an in-house payment action is selected.

53. The computer method as recited in claim 23 wherein confirmation is provided that a claim or bill review had been conducted by at least one second reviewer.

54. The computer method as recited in claim 23 wherein a list of claims for review is presented to the designated reviewer.

55. The computer method as recited in claim 23 wherein the reviewer may select one claim.

56. The computer method as recited in claim 23 wherein after a first review, a next claim may be selected for review.

57. The computer method as recited in claim 23 wherein a search of a data base for claims associated with one or more search criteria is performed.

58. The computer method as recited in claim 23 wherein the search criteria is selected from a group comprised of: a claim number, a social security number, or a patient name.

59. The computer method as recited in claim 23 wherein a route for review action is selected and a note.

60. The computer method as recited in claim 23 wherein the bill or claim is moved to a queue that initiates processes that forward the information to the selected examiner.

61. The computer method as recited in claim 23 wherein an indicator is provided to the selected examiner to notify of the need to review the claim or bill.

62. The computer method as recited in claim 23 wherein information is provided to a document source that prepares documents of payment and notification of existing insurance coverage amounts.

63. A computer system for managing medical insurance claim processing and bill payments comprising: input means operable to read at least one file containing one or more medical bill records and associated attachments associated with one of a plurality of medical providers; a memory in communication with said input means to store said at least one file; and a processor in communication with said memory operable to: identify which of said medical bill records relate to same ones of a medical provider; a means to select one of said files in accordance with a control and restrict access to said selected records to a designated reviewer; and a means to process each of said records identified as relating to said medical provider.

64. The computer system as recited in claim 63 wherein said means to process is operable to report the results of processing of each restricted selected record.

65. The computer system as recited in claim 63 wherein said processor is further operable to store the results of processing of each selected record.

66. The computer system as recited in claim 63 wherein said processor is further operable to validate said records.

67. The computer system as recited in claim 63 wherein said means to process is operable to select existing records prior to new records.

68. The computer system recited in claim 63 wherein access to said selected records comprises a selection from the group consisting of individual names, individual professional qualifications, management company accessing the records.

69. The computer system as recited in claim 63 wherein said reporting occurs at preselected intervals.

70. The computer system as recited in claim 63 wherein said reporting occurs upon detection of a predetermined event.

71. The computer system as recited in claim 63 wherein said means to store, stores the records at preselected intervals.

72. The computer system as recited in claim 64 wherein said storing occurs upon detection of a preprogrammed state.
